(19) United States
(12) Patent Application Publication
(10) Pub. No.: US 2003/0116045 A1
(43) Pub. Date: Jun. 26, 2003

(54) Washing bar for a printing press cylinder

(76) Inventor: Torsten Schmutz, Bobingen (DE)

Correspondence Address: OSTROLENK FABER GERB & SOFFEN, 1180 AVENUE OF THE AMERICAS, NEW YORK, NY, 100368403

(21) Appl. No.: 10/169,811

(22) PCT Filed: Jan. 5, 2001
(86) PCT No.: PCT/EP01/00066

(30) Foreign Application Priority Data
Jan. 8, 2000 (DE) 100 00 555.1

(51) Int. Cl. B41F 35/00

(52) U.S. Cl. 101/425

(57) ABSTRACT

The invention relates to a washing bar for a printing press cylinder. Said washing bar comprises a flexible pressing element (6) that has an arcuate cross section and whose longitudinal edges (16, 17) are inserted between an inner strip (12) and an outer strip (18, 19). The inner strip (12) is detachably fastened so that it can be pulled out of the pressing element (6) in the longitudinal direction of the washing bar.

The invention relates to a washing bar for a printing press cylinder according to the preamble of claim 1.

Accordingly, the invention relates to a washing bar for a printing press cylinder, comprising side parts and a crossmember connected to the latter, a pressing element for pressing a washing cloth section of a washing cloth onto the outer surface of a cylinder to be cleaned, the pressing element being positioned on the crossmember and extending in the longitudinal direction thereof, bearings in the side parts for the rotatable mounting of a clean cloth roller and a dirty cloth roller in order to move the washing cloth from the clean cloth roller over the pressing element onto the dirty cloth roller.

The invention is intended to achieve the object of providing a possible way in which the pressing element can be mounted and dismantled quickly in a simple manner.

In the case of a washing bar which contains a spray pipe for spraying the washing cloth with liquid, at the same time a possible way is to be provided for replacing the spray pipe quickly in a simple manner.

According to the invention, this object is achieved by the characterizing features of claim 1.

According to the invention, the washing bar is characterized in that the pressing element, as viewed in the transverse direction of the crossmember, extends arcuately over an inner strip, in that the two longitudinal edges of the pressing element are inserted between the inner strip and outer strips, in that the strips are connected to the crossmember, in that the longitudinal edges of the pressing element are seated on the crossmember and each have a lateral edge protrusion, over which the adjacent strip engages, in that the inner strip is detachably fastened to the crossmember by fastening means which are accessible from outside the pressing element, so that the inner strip on the latter is detachable and, following detachment, the inner strip can be withdrawn from the pressing element in the longitudinal direction of the crossmember.

Further features of the invention are contained in the subclaims.

The pressing element is preferably composed of a resilient material, for example rubber or plastic, and is normally also referred to as a pressing lip or pressing diaphragm.

The printing press cylinder which can be washed with the washing bar is, in particular, a rubber blanket cylinder, as it is known, in an offset printing press, but can also be any other cylinder or any other roll in an offset printing press or another printing press.

The invention will be described below with reference to the drawings and using preferred exemplary embodiments. In the drawings:

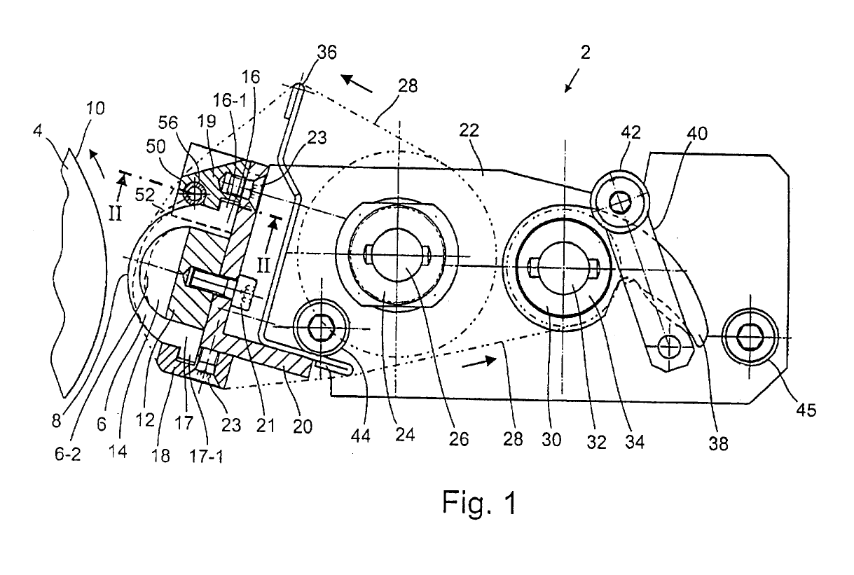

FIG. 1 shows in schematic form a side view of a washing bar according to the invention for washing the outer surface of a printing press cylinder,

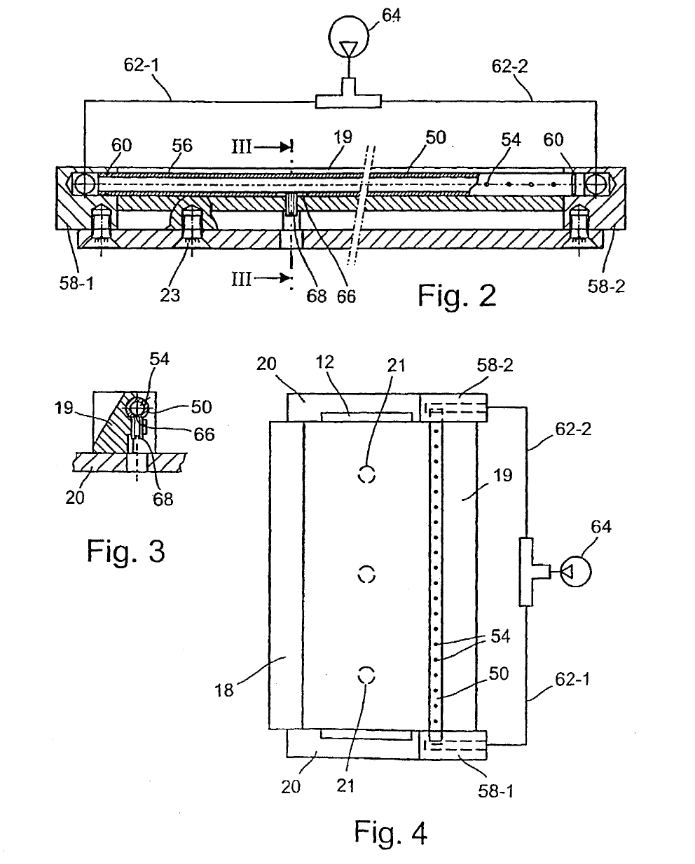

FIG. 2 shows a longitudinal view of a spray pipe from FIG. 1 with the elements holding said spray pipe, substantially in the plane II-II from FIG. 1, viewed in the direction of the arrows there,

FIG. 3 shows a cross-sectional view along the plane III-III from FIG. 2, viewed in the direction of the arrows there,

FIG. 4 shows a front view, not to scale, of substantial parts of the washing bar, viewed from the printing press cylinder,

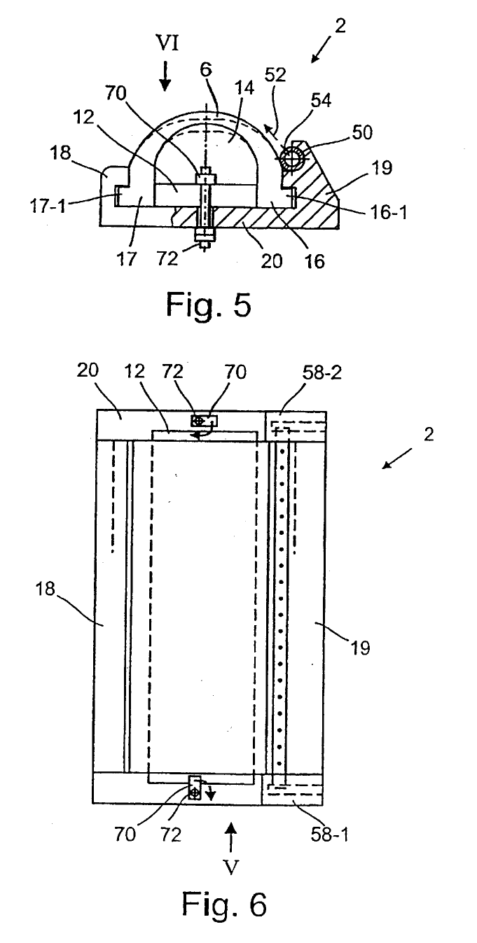

FIG. 5 shows a side view, not to scale, of a further embodiment of a holding device according to the invention, by means of which a washing cloth pressing element and a spray pipe can be replaced quickly,

FIG. 6 shows a plan view of the embodiment of FIG. 5.

The washing bar 2 for printing press cylinders 4, illustrated in the drawings, comprises a pressing element 6 for pressing a washing cloth section 8 onto the outer surface 10 of the cylinder 4 to be cleaned. The pressing element 6 is preferably a flexible lip made of rubber or plastic. According to FIG. 1, as viewed in cross section, it has a substantially semi-round or unshaped tunnel roof form and, between itself and an inner strip 12, forms a cavity 14. The cavity 14 can be inflated in order to make contact with and press the pressing element 6 onto the cylinder 4 with the washing cloth section 8 lying between them. According to the embodiment illustrated in the drawings, the cavity 14 cannot be inflated. Dashed lines 6-2 show how the pressing element 6 can be deformed by the cylinder 4. The washing bar 2 can be pushed forward automatically by a drive (not shown) from the basic position shown in FIG. 1, in which the pressing element 6 is at a distance from the cylinder 4, into a washing position, in which the pressing element 6 presses the washing cloth section 8 resting on it onto the outer surface 10 of the cylinder 4, and then back again into the basic position. After or during the withdrawal of the washing bar 2 from its washing position into its basic position, the pressing element 6 again assumes its original shape, illustrated by continuous lines, due to its own spring resilience.

The longitudinal edges 16 and 17 of the pressing element 6 are clamped in between a crossmember 20, the inner strip 12 and outer holding strips 18 and 19, which each extend over the entire length of the pressing element 6 and are fastened to the crossmember 20 by screws 21 and 23 or by means of quick-action connecting elements (clamping wedge or the like).

Following the removal of the screws 21 or loosening of the quick-action connecting elements of the inner strip 12, this inner strip 12 can be pulled out of the pressing element 6 in the strip longitudinal direction. The pressing element 6 can then be pulled out in the strip longitudinal direction between the outer strips 18 and 19 or can be compressed transversely with respect to the outer strips 18 and 19 and therefore freed from the latter and then be removed transversely or longitudinally. The insertion of the pressing element 6 and the inner strip 12 between the outer strips 18 and 19 is carried out in the reverse sequence.

The longitudinal edges 16 and 17 of the pressing element 6 are seated on the crossmember 20 and each have an edge protrusion 16-1 and 17-1 which project outward and over which the adjacent outer holding strip 18 or 19 engages.

The crossmember 20 connects side parts 22 of the washing bar to each other.

Located in the side parts 22 are bearings 24 for the rotatable mounting of a clean cloth roller 26, on which a clean washing cloth 28 is wound, and bearings 30 for a dirty cloth roller 32 for winding up the respectively dirty washing cloth section.

The dirty cloth roller 32 is provided with a free wheel drive 34, which rotates the dirty cloth roller 32 in each case and, as a result, transports the washing cloth onward from the clean cloth roller 26 over a deflection plate 36 and the pressing element 6 by a predetermined washing cloth section 8 when the washing bar 2 is moved from the basic position shown in FIG. 1 into the washing position transversely with respect to the cylinder 4. In the washing position, not shown, the pressing element 6 presses the washing cloth section 8 against the outer surface 10 of the cylinder 4 and, as a result, is deformed slightly, as shown by the dashed lines 6-2. The free wheel drive 34 is constructed in a similar way to a ratchet. It has a cloth driver lever 38, which, during the movement of the washing bar from the washing position (not shown) into the basic position (shown), bears on a stop on a holder and as a result is prevented from following the movement of the washing bar. During the reverse movement of the washing bar from the basic position shown into the washing position (not shown), the stop releases the cloth driver lever 38, so that, as a result of a spring contained in it, it can move back into the initial position, not rotating the dirty cloth roller 32 during this reverse movement, because of its free wheel.

The reverse movement or free wheel movement of the cloth driver lever 38 is limited by a sensor lever 40, which is provided with a roller 42 which rides on the washing cloth coil of the dirty cloth roller 34 and, as a result, determines the return distance in the free wheel direction of the cloth driver lever 38 as a function of the respective diameter of the dirty cloth coil. This means that, irrespective of the coil diameters of the washing cloth on the two rollers 32 and 26, each advance step of the washing cloth is approximately the same size.

On each side, the washing bar has two rollers 44 and 45, with which it can be moved between the basic position and the washing position in guides in a stationary holder.

A spray pipe 50 is arranged beside the movement path of the washing cloth 28 from the clean cloth roller 26 to the pressing element 6 in order to moisten the washing cloth 28 by means of a curtain-like spray jet 52 from a very large number of very small nozzle openings 54 in the spray pipe 50.

The spray pipe 50 is inserted into a channel 56 in the outer holding strip 19, in FIG. 1, and is supported therein by the holding strip so that it does not sag. The cross-sectional shape of the channel 56 is matched to the round shape of the spray pipe 50 and extends only partially, preferably by about 180°, around the spray pipe 50. The spray pipe 50 can be inserted radially into the channel 56 but, according to the preferred embodiment, is inserted axially into the channel 56 and can also be withdrawn axially from the latter.

As FIG. 2 shows, the spray pipe 50 is preferably detachably fastened to the crossmember 20 only at its ends by means of a fastening means 58-1 and 58-2 in each case.

The fastening means 58-1 and 58-2 are preferably mirror-image or identical liquid connection elements, into which the ends of the spray pipe 50 are plugged in a liquid-tight manner. Sealing is preferably achieved by means of O-rings 60, which are pushed onto the pipe ends. The liquid connection elements 58-1 and 58-2 are connected via liquid lines 62-1 and 62-2 to a liquid source 64. From the liquid source 64, liquid, for example water, is in each case then sprayed onto the washing cloth 28 via the nozzle openings 54 in the spray pipe 50 while or shortly before the washing cloth 28 is being moved one step further toward the pressing element 6. The spray jet 52 is preferably aimed into the inlet wedge between this washing cloth 28 and the pressing element 6.

In order to remove the spray pipe 50, only one of the two liquid connection elements 58-1 or 58-2 needs to be unscrewed from the crossmember 20. The spray pipe 6 can then be pulled axially out of the other liquid connection element 58-1 or 58-2 and out of the channel 56 in the holding strip 19. This means that there is very little mounting effort. According to a different embodiment, the liquid connection element 58-1 or 58-2 to be removed from one pipe end could also be arranged to be displaceable longitudinally on the crossmember 20. According to a still further embodiment, the liquid connection elements 58-1 and 58-2 could be detachably fastened-to the outer holding strip 19, which carries the spray pipe 50, instead of to the crossmember 20.

In all the embodiments there is the advantage that a large number of screws over the entire length of the washing bar, whose length corresponds to the length of the cylinder 4 to be cleaned, no longer need to be loosened, but only a single screw or another fastening element, with which the liquid connection element is fastened to the crossmember 20 (or the outer holding strip 19).

According to other embodiments, there is also the possibility of constructing only one of the two fastening means 58-1 and 58-2 as liquid connection elements, or neither of the two, if the liquid is fed to the spray pipe 50 in another way, for example at a point removed from the spray-pipe ends, for example at the center of the spray pipe.

On its outer circumference, the spray pipe 50 is preferably provided with a flat 66, against which there presses a positioning screw 68 which is screwed through the outer holding strip 19 which carries the spray pipe 50. As a result, the rotational angle position of the spray nozzle openings 54 relative to the holding strip 19 is defined. This positioning screw 88 has to be unscrewed in each case if the spray pipe 50 is withdrawn from or inserted into the channel 56 in the outer holding strip 19 axially instead of radially.

One and/or the other of the two outer holding strips 18 and 19, together with the crossmember 20, can be a single-part piece of material.

FIGS. 5 and 6 show an embodiment in which both outer holding strips 18 and 19 together with the crossmember 20 are a single-part piece of material. Furthermore, FIGS. 5 and 6 show a possible way of fastening the inner strip 12 detachably to the crossmember 20 by means of quick-action fastening elements 70 instead of by means of screws 21. The quick-action fastening elements 70 can be pivoted against the inner strip 12 about a pivot 72 which is mounted in the crossmember 20.

The inner strip 12 can be constructed in such a way that it engages laterally over the longitudinal edges 16, 17 of the preferably compressibly elastic pressing element 6, and preferably clamps it against the crossmember 20 and/or the outer holding strips 18, 19. For this purpose, the inner strip 12 can have lateral edge protrusions, for example with a vertical spacing above the crossmember 20, which engage over inner edge protrusions on the pressing elements 6 or, as viewed in cross section, can have a dovetail shape or trapezoidal shape, the width of the strip being smallest close to the crossmember 20 and becoming greater with increasing distance from the crossmember.

1. A washing bar for a printing press cylinder, comprising side parts (22) and a crossmember (20) connected to the latter, a pressing element (6) for pressing a washing cloth section (8) of a washing cloth (28) onto the outer surface of a cylinder (4) to be cleaned, the pressing element (6) being positioned on the crossmember and extending in the longitudinal direction thereof, bearings (24, 30) in the side parts (22) for the rotatable mounting of a clean cloth roller (26) and a dirty cloth roller (32) in order to move the washing cloth (28) from the clean cloth roller over the pressing element (6) onto the dirty cloth roller, characterized in that
the pressing element (6), as viewed in the transverse direction of the crossmember, extends arcuately over an inner strip (12), in that the two longitudinal edges (18, 19) of the pressing element (6) are inserted between the inner strip (12) and outer strips (18, 19), in that the strips (12, 18, 19) are connected to the crossmember (20), in that the longitudinal edges (16, 17) of the pressing element (6) are seated on the crossmember (20) and each have a lateral edge protrusion (16-1, 17-1), over which the adjacent strip (18, 19) engages, in that the inner strip (12) is detachably fastened to the crossmember (20) by fastening means (21; 70) which are accessible from outside the pressing element (6), so that the inner strip on the latter is detachable and, following detachment, the inner strip (12) can be withdrawn from the pressing element (6) in the longitudinal direction of the crossmember.

2. The washing bar as claimed in claim 1, characterized in that the lateral edge protrusions (16-1, 17-1) project outward in the transverse direction of the crossmember, and the outer strips (18, 19) engage over them.

3. The washing bar as claimed in claim 1 or 2, characterized in that the fastening means have screws (21) which extend through the crossmember (20) and are screwed into the inner strip (12).

4. The washing bar as claimed in claim 1 or 2, characterized in that the fastening means have quick-action connecting means (70), by means of which the inner strip (12) is detachably connected to the crossmember (20).

5. The washing bar as claimed in one of the preceding claims, characterized in that the crossmember (20) and at least one of the two outer strips (18, 19) are together a single-part piece of material.

6. The washing bar as claimed in one of claims 1 to 4, characterized in that at least one of the two outer strips (18, 19) is fastened to the crossmember (20).

7. The washing bar as claimed in one of the preceding claims, characterized in that the longitudinal edges of the pressing element (6) are clamped in between the crossmember (20), the inner strip (12) and the outer strips (18, 19).

8. The washing bar as claimed in one of the preceding claims, characterized in that a spray pipe (50) for moistening the washing cloth (28) is inserted into a channel (56) in one of the two outer strips (18, 19) and is supported therein by this outer strip (19) in the transverse direction of the pipe, and in that fastening means (58-1, 58-2) are provided for the detachable fastening of the spray pipe (50) at the two pipe ends.

9. The washing bar as claimed in claim 8, characterized in that the pipe fastening means (58-1, 58-2) have, at at least one pipe end, a mount into which the pipe end can be inserted axially in a liquid-tight manner and from which it can be removed axially, in that the pipe fastening means of at least the relevant other pipe end is arranged such that it can be taken away in such a way that, after this pipe fastening means has been taken away, the pipe can be removed axially from the mount of the one pipe fastening means and, after this removal, can also be removed from the channel in the outer strip, and in that the pipe fastening means, at at least one pipe end, have a liquid inlet to supply liquid into the pipe end held by it.

10. The washing bar as claimed in claim 9, characterized in that the mount is a plug-in mount which, with the relevant pipe end, forms a plug-in coupling.
